(19) United States
(12) Patent Application Publication
(10) Pub. No.: US 2012/0173424 A1
(43) Pub. Date: Jul. 5, 2012

(54) PAYMENT SYSTEM AND METHOD BY IDENTIFYING FINGERPRINTS

(75) Inventors: CHIA-MING YEH, Tu-Cheng (TW); CHUANG-WEI TSENG, Tu-Cheng (TW)

(73) Assignee: HON HAI PRECISION INDUSTRY CO., LTD., Tu-Cheng (TW)

(21) Appl. No.: 13/220,710

(22) Filed: Aug. 30, 2011

(30) Foreign Application Priority Data
Dec. 30, 2010 (TW) 099147060

(51) Int. Cl. G06Q 40/00

(52) U.S. Cl. 705/44

(57) ABSTRACT

A fingerprint of a user can be used to identify the user. A cloud server of a data center receives the fingerprint of the user from a fingerprint input device. The cloud server of the data center determines if the received fingerprint matches a predetermined fingerprint pre-stored in the cloud server. A prompt is displayed for prompting the user for payment on a display device of a client connected to the cloud server, in response to a determination that the received fingerprint matches the predetermined fingerprint.

### BACKGROUND

1. Technical Field

The embodiments of the present disclosure relate to cloud computing technology, and particularly to a payment system and method for payment by identifying a fingerprint via cloud computing.

2. Description of Related Art

A credit card is a small plastic card issued to consumers by a bank. It is a card entitling its cardholder to buy goods and services based on the cardholder's promise to pay for these goods and services. The issuer of the credit card grants a line of credit to the cardholder from which the cardholder can borrow money for payment to a merchant. However, if a credit card is lost, someone else could use it, and then the cardholder may lose money.

### BRIEF DESCRIPTION OF THE DRAWINGS

FIG. 1 is a system view of one embodiment of a payment system.

FIG. 2 is a block diagram of one embodiment of a cloud server included in FIG. 1.

FIG. 3 is a flowchart of one embodiment of a payment method.

FIG. 4 is a detailed description of one block S305 in FIG. 3 of one embodiment of a method for validating a fingerprint of a user.

FIG. 5 illustrates one embodiment of a voltage graph of a fingerprint scan including main characteristic points and sub characteristic points.

FIG. 6 illustrates one embodiment of a graphical representation of exemplary fingerprint characteristic points in accordance with one exemplary embodiment.

FIG. 7 illustrates one embodiment of a graphical representation of a coordinate system oriented on characteristic points in accordance with one exemplary embodiment.

### DETAILED DESCRIPTION

The disclosure is illustrated by way of examples and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

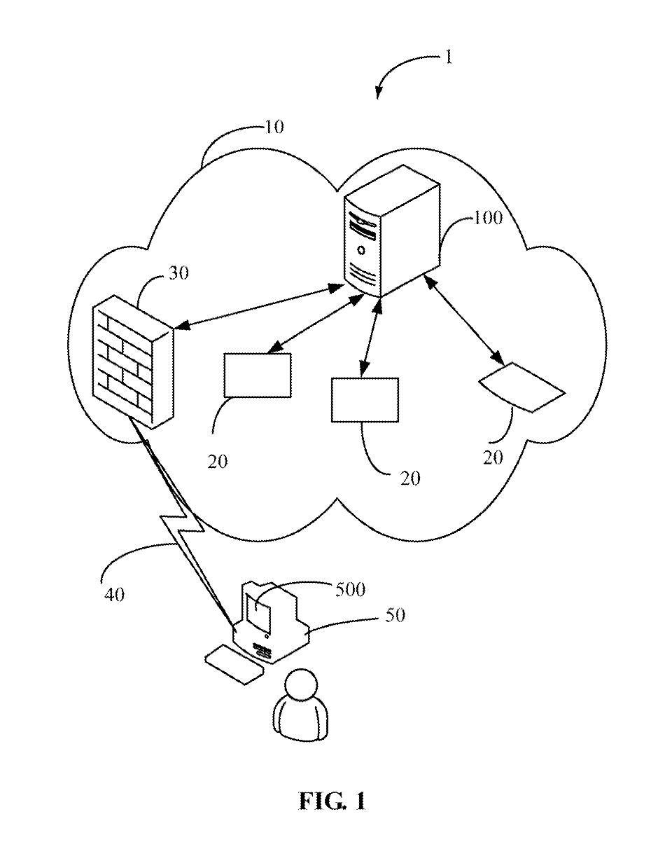

FIG. 1 is a block diagram of one embodiment of a payment system 1. In one embodiment, the payment system 1 may include a data center 10, a network 40 and one or more clients 50. The payment system 1 may be used to make a payment using a fingerprint scan of a user.

The data center 10 is located behind a firewall 30 and connected to the network 40. The network 40 may be, but is not limited to, a wide area network (e.g., the Internet) or a local area network. The firewall 30 is used to protect the data center 10 from unauthorized access and secure the information of the data center 10. The data center 10 is designed for cloud computing capability and capacity and includes a plurality of cloud servers 100. The cloud servers 100 are connected to the one or more finger input devices 20 using a wireless connection. The wireless connection may be, but is not limited to, a BLUETOOTH connection, a local area network, a global system for mobile communication (GSM) network, or a code division multiple access (CDMA) for mobile communication network.

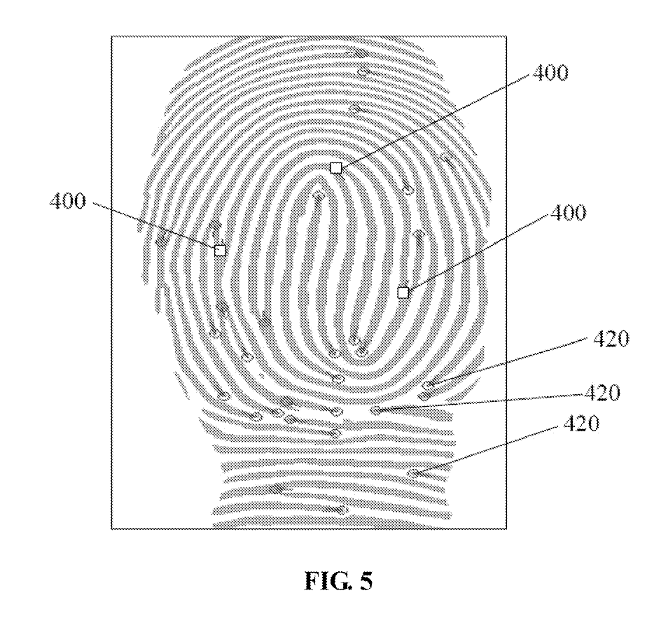

The each of the one or more finger input devices 20 includes a touch panel. The touch panel generates a voltage graph when the user presses his/her finger onto the touch panel. Voltage of the touch panel changes in response to the finger contacting the touch panel. The changed voltage is output to an analog/digital (A/D) converter to obtain the voltage graph of the scan of the fingerprint of the user. The finger input device 20 may be, but is not limited to, an optical charge coupled device (CCD) finger input device or a complementary metal oxide semiconductor (CMOS) finger input device. Exemplary voltage graphs are shown in FIG. 5 and are described in greater detail below.

The cloud server 100 is a dynamic host configuration protocol (DHCP) server. In one embodiment, the cloud server 100 assigns IP addresses to the client 50. The cloud server 100 may provide three modes for allocating IP addresses to the clients 50. The modes are dynamic allocation, automatic allocation, and static allocation. In one embodiment, the cloud server 100 uses dynamic allocation to assign the IP addresses to the clients 50. The cloud server 100 further sets a password (e.g., 123456$) and a name (e.g., apple) for enabling the client 50 to access the data center 10. The cloud server 100 also provides an access privilege for each client 50 according to the assigned IP address and the name. Additionally, the cloud server 100 may be a personal computer (PC), a network server, or any item of other data-processing equipment. Further details of the cloud server 10 will be described below.

The client 50 is electronically connected to the network 40. Additionally, the client 50 provides a user interface on the display for a user to access the data center 10 to control one or more operations of the cloud server 100. For example, the user may input a password and name by an input device (e.g., keyboard) into the user interface on a display device 500 of the client 50 to access the data center 10.

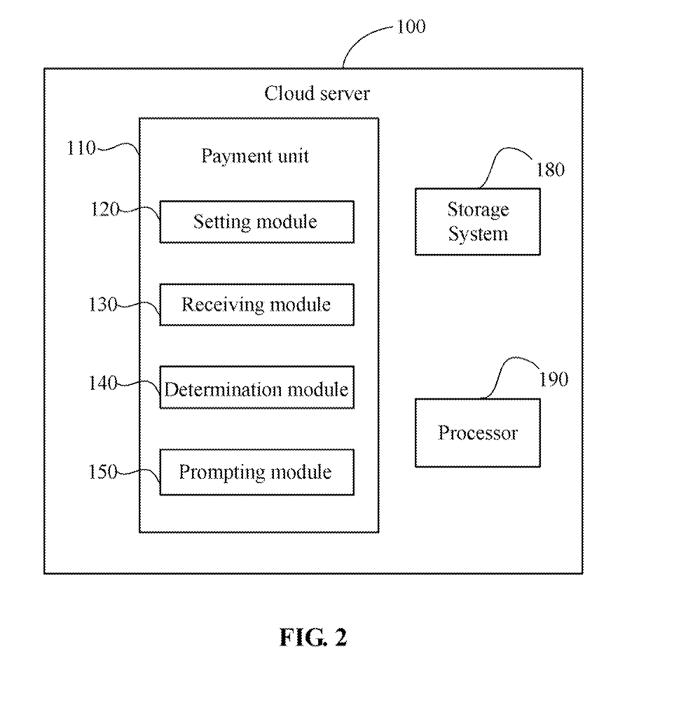

FIG. 2 is a block diagram of one embodiment of the cloud server 100. The cloud server 100 includes a payment unit 110. The payment unit 110 may be used to swipe a credit card by identifying the fingerprint. In one embodiment, the cloud server 100 includes a storage system 180, at least one processor 190. In one embodiment, the payment unit 110 includes a setting module 120, a receiving module 130, a determination module 140, and a prompt module 150. The modules 120-150 may include computerized code in the form of one or more programs that are stored in a storage system 180. The computerized code includes instructions that are executed by the at least one processor 190 to provide functions for the modules 120-150. The storage system 180 may be a cache or a memory, such as an EPROM, HDD, or flash memory.

The setting module 120 sets identification information used in order to access the cloud server 100 of the data center 10 and assigns the identification information to the client 50. In one embodiment, the identification information includes a name of the credit cardholder, a credit card number, an issued date of the credit card, an expiration date of the credit card, and a timestamp of the authorization information. The identification information of each client 50 is also stored in the storage system 180.

The receiving module 130 receives credit card information of a user to access the cloud server 100 of the data center 10 from the client 50. The credit card information includes a name of the credit cardholder, a credit card number, an issued date of the credit card, an expiration date of the credit card, and a timestamp. In one embodiment, the user inputs credit card information in the user interface of the client 50 to access the cloud server 100 of the data center 10.

The determination module 140 determines if the credit card information matches the identification information. In one embodiment, the determination module 140 compares the identification information of the client 50 that is stored in the storage system 180 with the credit card information, if the identification information is the same as the credit card information contained, the client 50 is permitted to access the cloud server 100 of the data center 10. Otherwise, if the identification information is different from the credit card information, the client 50 is not permitted to the cloud server 100 of the data center 10.

The receiving module 130 further receives a fingerprint scan of the user from the fingerprint input device 20, in response to a determination that the credit card information matches the identification information.

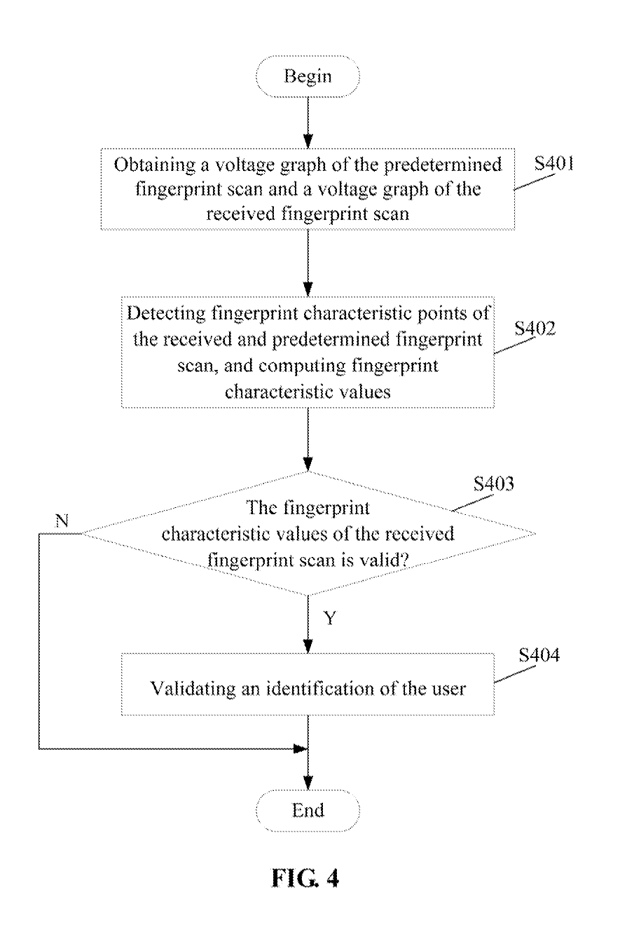

The determining module 140 further determines if the received fingerprint scan matches a predetermined scan of the fingerprint. Further details of the determination will be described below in FIG. 4.

The prompting module 150 displays a prompt for prompting the user to make a payment on the display device 500 of the client 50. In one embodiment, the prompting module 150 pops up a dialog box on the display device 500 of the client 50 to prompt the user to input an amount to be paid.

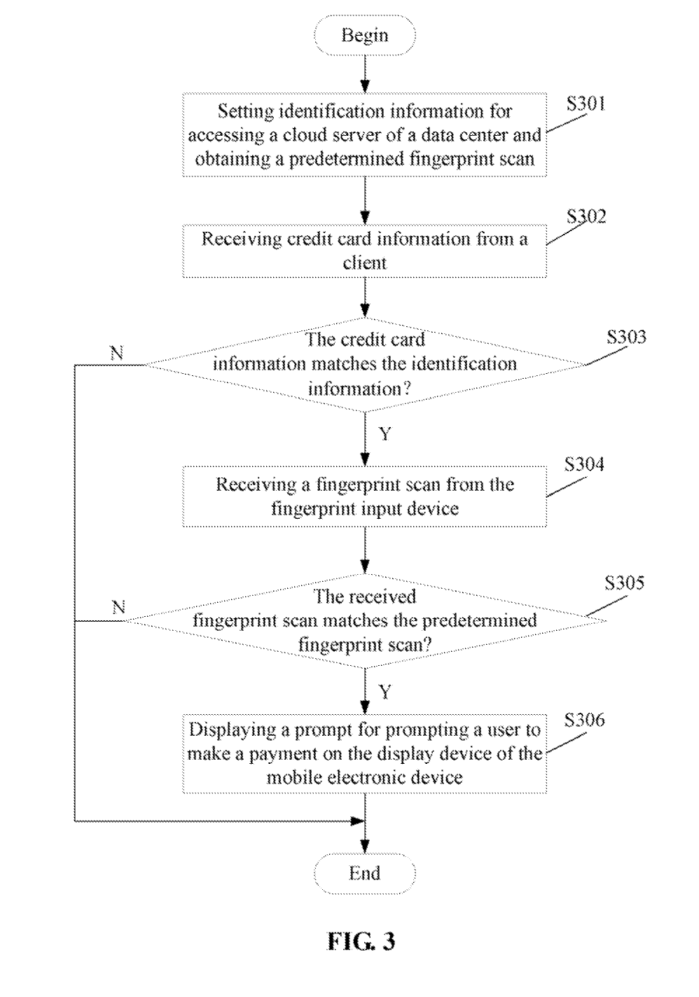

FIG. 3 is a flowchart of one embodiment of a payment method. Depending on the embodiment, additional blocks may be added, others deleted, and the ordering of the blocks may be changed.

In block S301, the setting module 120 sets identification information used in order to access the cloud server 100 of the data center 10 and assigns the identification information to the client 50. As mentioned above, the identification information includes a name of the credit cardholder, a credit card number, an issued date of the credit card, an expiration date of the credit card, and a timestamp of the authorization information.

In block S302, the receiving module 130 receives the credit card information of a user to access the cloud server 100 of the data center 10 from the client 50. The credit card information includes a name of the credit cardholder, a credit card number, an issued date of the credit card, an expiration date of the credit card, and a timestamp. In one embodiment, the user inputs credit card information in the user interface of the client 50 to access the cloud server 100 of the data center 10.

In block S303, the determination module 140 determines if the credit card information matches the identification information. In one embodiment, the determination module 140 compares the identification information of the client 50 that is stored in the storage system 180 with the credit card information, if the identification information is the same as the credit card information contained, the client 50 is permitted to access the cloud server 100 of the data center 10, the procedure goes to the block S304. Otherwise, if the identification information is different from the credit card information, the client 50 is not permitted to the cloud server 100 of the data center 10, the procedure ends.

In block S304, the receiving module 130 receives a fingerprint scan of the user from the fingerprint input device 20.

In block S305, the determining module 140 further determines if the received fingerprint scan matches the predetermined fingerprint scan. In one embodiment, if the received fingerprint scan matches the predetermined fingerprint scan, the procedure goes to the block S306. Otherwise, if the received fingerprint scan does not match the predetermined fingerprint scan, the procedure ends.

In block S306, the prompting module 150 displays a prompt on the display device 500 of the client 50 for prompting the user to make a payment. As mentioned above, the prompting module 150 pops up a dialog box on the display device 500 of the client 50 to prompt the user to input an amount to be paid. For example, the dialog box may contain, but is not limited to, a message saying “You can pay now, please input the amount of money!”.

FIG. 4 is a detailed description of one block S305 in FIG. 3 of one embodiment for validating the fingerprint.

In block S401, the determination module 140 obtains a voltage graph of the predetermined fingerprint scan from the storage system 180, and a voltage graph of the received fingerprint scan inputted by a user. In one embodiment, the determination module 140 obtains the voltage graph of the received fingerprint scan when the user presses a finger on the touch panel.

In block S402, the determination module 140 detects predetermined fingerprint characteristic points in the predetermined voltage graph of the predetermined fingerprint scan, and computes the predetermined fingerprint characteristic values according to the predetermined fingerprint characteristic points. FIG. 5 shows an example of exemplary characteristic points of fingerprint characteristic points or fingerprint characteristic points of a fingerprint. In FIG. 5, the voltage graph of the fingerprint is highlighted with a plurality of circular parts 40 and rectangular parts 42. The circular parts 40 and the rectangular parts 42 indicate the characteristic points detected in the voltage graph. The circular parts 40 represent sub-characteristic points, which include whorls and a triradius of the fingerprint. The rectangular parts 42 represent main characteristic points, which include broken fingerprint ridges and bifurcating fingerprint ridges.

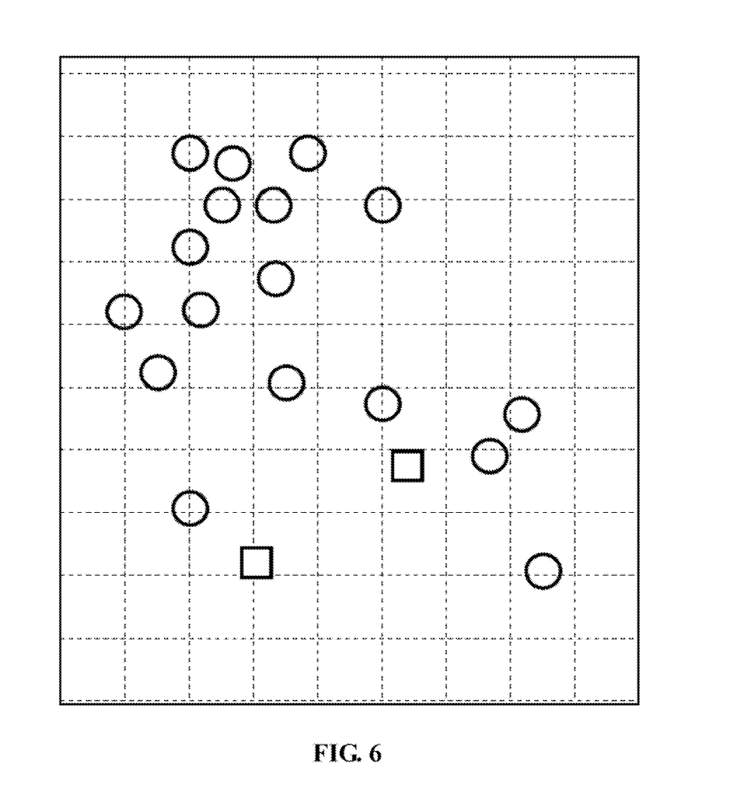

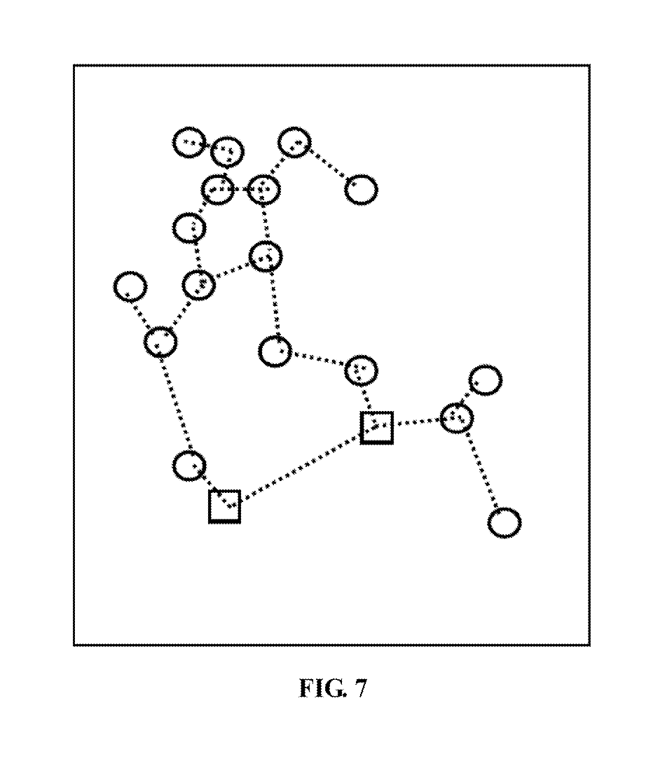

FIG. 6 shows a graphical representation of the characteristic points of the fingerprint plotted on a coordinate system in accordance with one exemplary embodiment. The coordinates of the characteristic points may be defined according to the coordinate system of FIG. 6. In the illustrated embodiment of FIG. 6, a count of the rectangular parts is 2, which indicates that the fingerprint has 2 main characteristic points. The count of the circular parts is 17, which indicates that the fingerprint has 17 sub-characteristic points. FIG. 7 shows a graphical representation of a linked shape of the characteristic points of a fingerprint in accordance with one exemplary embodiment. The process of linking the characteristic points to form the linked shape involves computing relative positions between adjacent characteristic points and connecting centers of the adjacent characteristic points according to the computed relative positions.

Additionally, the determination module 140 detects received fingerprint characteristic points in the received voltage graph of the received fingerprint scan, and computes the received fingerprint characteristic values according to the received fingerprint characteristic points. The process of detecting received fingerprint characteristic points and computing received fingerprint characteristic values is the same as the process of detecting the predetermined fingerprint characteristic points and computing the predetermined fingerprint characteristic values.

In block S403, the determining module 140 determines if the fingerprint characteristic values of the fingerprint is valid. In one embodiment, the determining module determines if the computed fingerprint characteristic values match the predetermined fingerprint characteristic values. For example, if a count of the main characteristic points in the fingerprint characteristic points is equal to a count of the main characteristic points of the predetermined fingerprint scan, and a count of the sub-characteristic points in the fingerprint characteristic points is more than 60 percent of a count of the sub-characteristic points of the predetermined fingerprint scan, then the received fingerprint characteristic values are determined to match the characteristic values of the predetermined fingerprint scan, and the fingerprint characteristic values of the received fingerprint is valid.

In block S404, the determining module validates identification of the user, in response to a determination that the fingerprint characteristic values of the received fingerprint scan matches the fingerprint characteristic values of the predetermined fingerprint scan.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A cloud server of a data center, the cloud server in electronic communication with a fingerprint input device, comprising:
a storage system storing identification information;
at least one processor; and
one or more programs stored in the storage system and being executable by the at least one processor, the one or more programs comprising:
a receiving module operable to receive credit card information input by a user from a client in electronic communication with the cloud server;
a determination module operable to determine if the credit card information input by the user matches the identification information;
the receiving module operable to receive a fingerprint scan of the user from the fingerprint input device, in response to a determination that the credit card information input by the user matches the identification information;
a determining module operable to determine if the received fingerprint scan matches a predetermined scan of the fingerprint pre-stored in the cloud server; and
a prompting module operable to display a prompt on a display device of the client, the prompt requesting the user to make a payment in response to a determination that the received fingerprint scan matches the predetermined fingerprint scan.

2. The cloud server of the data center of claim 1, wherein the credit card information and the identification information comprises a name of the credit cardholder, a credit card number, an issued date of the credit card, an expiration date of the credit card, and a timestamp.

3. The cloud server of the data center of claim 1, wherein fingerprint input device is an optical charge coupled device (CCD) finger input device or a complementary metal oxide semiconductor (CMOS) finger input device.

4. A payment method implemented by a cloud server of a data center, the cloud server in electronic communication with a fingerprint input device, the method comprising:
receiving credit card information input by a user from a client in electronic communication with the cloud server;
determining if the credit card information input by the user matches identification information storing in a storage system of the cloud server;
receiving a fingerprint scan of the user from the fingerprint input device, in response to a determination that the credit card information input by the user matches the identification information;
determining if the received fingerprint scan matches a predetermined scan of the fingerprint pre-stored in the cloud server; and
displaying a prompt on a display device of the client, the prompt requesting the user to make a payment in response to a determination that the received fingerprint scan matches the predetermined fingerprint scan.

5. The method of claim 4, wherein the wherein the credit card information and the identification information comprises a name of the credit cardholder, a credit card number, an issued date of the credit card, an expiration date of the credit card, and a timestamp.

6. The method of claim 4, wherein fingerprint input device is an optical charge coupled device (CCD) finger input device or a complementary metal oxide semiconductor (CMOS) finger input device.

7. The method of claim 5, wherein the block of determining if the received fingerprint scan matches the predetermined fingerprint scan comprises:
obtaining a voltage graph of the predetermined fingerprint scan from the storage system, and a voltage graph of the received fingerprint scan inputted by the user from the fingerprint input device;
detecting predetermined fingerprint characteristic points in the predetermined voltage graph of the predetermined fingerprint scan, and computing the predetermined fingerprint characteristic values according to the predetermined fingerprint characteristic points;
detecting received fingerprint characteristic points in the received voltage graph of the received fingerprint scan, and computing the received fingerprint characteristic values according to the received fingerprint characteristic points;
determining if the fingerprint characteristic values of the received fingerprint scan matches the fingerprint characteristic values of the predetermined fingerprint scan; and
validating identification of the user, in response to a determination that the fingerprint characteristic values of the received fingerprint scan matches the fingerprint characteristic values of the predetermined fingerprint scan.

8. The method of claim 7, wherein the received fingerprint characteristic points and predetermined fingerprint characteristic points comprise main characteristic points and sub-characteristic points in the voltage graph of the fingerprint.

9. The method of claim 8, wherein the main characteristic points comprise a whorl and a triradius in the voltage graph of the fingerprint, and the sub-characteristic points comprises broken fingerprint ridges and bifurcating fingerprint ridges in the voltage graph of the fingerprint.

10. The method of claim 8, wherein the received fingerprint characteristic values and the predetermined fingerprint characteristic values comprise a characteristic point count, characteristic point coordinates, a linked shape of the characteristic points, and relative positions between adjacent characteristic points.

11. A non-transitory computer-readable medium having stored thereon instructions that, when executed by a cloud server of a data center, the cloud server in electronic communication with a fingerprint input device, causing the cloud server to perform a payment method, the method comprising:
receiving credit card information input by a user from a client in electronic communication with the cloud server;
determining if the credit card information input by the user matches identification information storing in a storage system of the cloud server;
receiving a fingerprint scan of the user from the fingerprint input device, in response to a determination that the credit card information input by the user matches the identification information;
determining if the received fingerprint scan matches a predetermined scan of the fingerprint pre-stored in the cloud server; and
displaying a prompt on a display device of the client, the prompt requesting the user to make a payment in response to a determination that the received fingerprint scan matches the predetermined fingerprint scan.

12. The medium of claim 11, wherein the wherein the credit card information and the identification information comprises a name of the credit cardholder, a credit card number, an issued date of the credit card, an expiration date of the credit card, and a timestamp.

13. The medium of claim 11, wherein fingerprint input device is an optical charge coupled device (CCD) finger input device or a complementary metal oxide semiconductor (CMOS) finger input device.

14. The medium of claim 11, wherein the method of the block of determining if the received fingerprint matches the predetermined fingerprint comprises:
obtaining a voltage graph of the predetermined fingerprint scan from the storage system, and a voltage graph of the received fingerprint scan inputted by the user from the fingerprint input device;
detecting predetermined fingerprint characteristic points in the predetermined voltage graph of the predetermined fingerprint scan, and computing the predetermined fingerprint characteristic values according to the predetermined fingerprint characteristic points;
detecting received fingerprint characteristic points in the received voltage graph of the received fingerprint scan, and computing the received fingerprint characteristic values according to the received fingerprint characteristic points;
determining if the fingerprint characteristic values of the received fingerprint scan matches the fingerprint characteristic values of the predetermined fingerprint scan; and
validating identification of the user, in response to a determination that the fingerprint characteristic values of the received fingerprint scan matches the fingerprint characteristic values of the predetermined fingerprint scan.

15. The medium of claim 14, wherein the received fingerprint characteristic points and predetermined fingerprint characteristic points comprise main characteristic points and sub-characteristic points in the voltage graph of the fingerprint.

16. The medium of claim 15, wherein the main characteristic points comprise a whorl and a triradius in the voltage graph of the fingerprint, and the sub-characteristic points comprises broken fingerprint ridges and bifurcating fingerprint ridges in the voltage graph of the fingerprint.

17. The medium of claim 15, wherein the received fingerprint characteristic values and the predetermined fingerprint characteristic values comprise a characteristic point count, characteristic point coordinates, a linked shape of the characteristic points, and relative positions between adjacent characteristic points.
